(19) United States
(12) Patent Application Publication
(10) Pub. No.: US 2006/0128314 A1
(43) Pub. Date: Jun. 15, 2006

(54) Apparatus and method for displaying a moving speed in a mobile communication terminal for mobile Internet

(75) Inventor: Jae-Hyoung Kim, Anyang-si (KR)

Correspondence Address: DILWORTH & BARRESE, LLP, 333 EARLE OVINGTON BLVD., UNIONDALE, NY, 11553, US

(73) Assignee: SAMSUNG ELECTRONICS CO., LTD., Suwon-si (KR)

(21) Appl. No.: 11/301,414

(22) Filed: Dec. 13, 2005

(30) Foreign Application Priority Data
Dec. 14, 2004 (KR) 2004-105857

(51) Int. Cl. H04B 17/00

(52) U.S. Cl. 455/67.11

(57) ABSTRACT

An apparatus and method for displaying a moving speed of a mobile communication terminal for use with mobile Internet. The method includes sensing the moving speed of the mobile communication terminal, computing the sensed moving speed, and displaying the moving speed. The moving speed is computed using frequency offsets of subcarriers generated in a mobile Internet system. The moving speed can be displayed by a visual indicator, such as color, or numerically.

### PRIORITY

This application claims priority to an application Ser. No. ______ entitled “Apparatus and Method for Displaying User's Moving Speed in Mobile Communication Terminal for Mobile Internet”, filed in the Korean Industrial Property Office on Dec. 14, 2004 and assigned Serial No. 2004-105857, the contents of which are incorporated herein by reference.

### BACKGROUND OF THE INVENTION

1. Field of the Invention

The present invention relates generally to a speed display apparatus and method in a mobile communication terminal, and more particularly to a speed display apparatus and method for measuring and visualizing a moving speed of a mobile communication terminal for mobile Internet.

2. Description of the Related Art

In recent years, as the use of multi-function mobile communication terminals has become wide spread, mobile communication terminal users can receive telephone call services and various additional services. Further, as the number of various services and additional functions increase, mobile communication terminals through which a user can access the Internet via wireless have been developed. More specifically, the technology that enables mobile users to connect by wireless to mobile communication terminals and access the Internet has been developed, i.e., mobile Internet. A technology for mobile Internet is commonly referred to as “WiBro”, an abbreviation for “wireless broadband Internet.”

WiBro is a high-speed data communication technology for networking, which adds mobility to a wireless local area network (LAN), thus enabling a mobile communication terminal to access the Internet while moving. Also, WiBro is a technology providing high-speed mobile Internet, such as a wireless LAN, through which a user can receive data communications via the Internet and long-distance communication services via a mobile phone, at a frequency of 2.3 GHz.

Advancement in the technology for wireless Internet has resulted in an increase in the size of a display screen of a mobile communication terminal and the number of colors. Accordingly, there is a growing need for an effective and multifaceted use of the display window of the mobile communication terminal, based on the advantages of the mobile communication terminal for mobile Internet.

Further, various additional functions of the mobile communication terminal for mobile Internet are required to be associated with the display functions thereof in order to increase the utilities of the display functions and satisfy various user needs.

For example, to increase the utilities of the display functions, mobile communication terminals for mobile Internet have been improved to display moving images on a display window thereof. However, conventionally, the display functions are provided to display an image or moving image on a display screen without respect to the movement of the mobile terminal, that is, the user's moving speed. Also, for most folder-type mobile communication terminals, when a folder is open, light-emitting units included in both a display window and a keypad are all switched on to emit only a color.

However, users of mobile communication terminals have recently desired to purchase mobile communication terminals that display more convenient and interesting functions. Therefore, manufacturers of mobile communication terminals have tried to develop new and interesting functions based on the existing display functions. However, conventionally, light-emitting units installed in a keypad of a mobile communication terminal are simply switched on/off according to user manipulation of the keypad, thus not satisfying the emerging needs of the user.

### SUMMARY OF THE INVENTION

Accordingly, the present invention has been designed to solve the above and other problems occurring in the prior art.

An object of the present invention is to provide a speed display apparatus and method for measuring and visualizing a moving speed of a mobile communication terminal, utilizing a mobile Internet function.

In order to accomplish the above and other objects, there is provided an apparatus for displaying a moving speed of a mobile communication terminal for use with mobile Internet. The apparatus includes a receiving unit receiving a signal from a base station, a phase-locked loop transforming the signal received from the receiving unit into a desired frequency channel signal to measure subcarrier frequency offsets, a control unit computing the moving speed of the mobile terminal using the subcarrier frequency offsets measured using the signal received from the receiving unit and outputting a control signal corresponding to the computed moving speed, and a light-emitting unit emitting at least one color in response to the control signal.

In accordance with another aspect of the present invention, there is provided a method of displaying a moving speed of a mobile communication terminal for use with mobile Internet. The method includes extracting subcarrier components from a received signal by transforming the received signal into a frequency domain; determining if the mobile communication terminal is moved by analyzing the extracted subcarrier components; computing the moving speed of the mobile terminal when it is determined that the mobile communication terminal is moved; and controlling a light-emitting unit to emit a color corresponding to the computed moving speed.

### BRIEF DESCRIPTION OF THE DRAWINGS

The above and other objects, features, and advantages of the present invention will be more apparent from the following detailed description taken in conjunction with the accompanying drawings, in which:

FIG. 1 is a frequency synchronization process performed in a mobile Internet system;

FIG. 2 is a table illustrating allocation of WiBro frequency channels at a frequency band of 10 MHz according to an embodiment of the present invention;

FIG. 3 illustrates subcarrier frequency offsets according to an embodiment of the present invention;

FIG. 4 is a block diagram illustrating a mobile communication terminal that emits a color corresponding to a moving speed, according to an embodiment of the present invention;

FIG. 5 is a view illustrating waveforms of signals generated according to a moving speed of a mobile terminal, according to an embodiment of the present invention; and

FIG. 6 is a flowchart illustrating a method of emitting a color corresponding to a moving speed of a mobile communication terminal, according to an embodiment of the present invention.

### DETAILED DESCRIPTION OF THE PREFERRED EMBODIMENTS

Preferred embodiments of the present invention will be described in detail hereinafter with reference to the accompanying drawings. In the drawings, the same or similar elements are denoted by the same reference numerals even though they are depicted in different drawings. In the following description, a detailed description of known functions and configurations incorporated herein has been omitted for clarity and conciseness.

The present invention proposes a mobile communication terminal for use with mobile Internet, which is capable of emitting a color corresponding to a moving speed. According to the present invention, the moving speed of the mobile communication terminal is sensed, the sensed moving speed is computed, and a color corresponding to the moving speed is emitted. The moving speed is computed using frequency offsets of subcarriers generated in a mobile Internet system. Accordingly, the mobile communication terminal according to the present invention is capable of emitting a color corresponding to a moving speed indoors and outdoors without an interruption, thereby increasing user convenience.

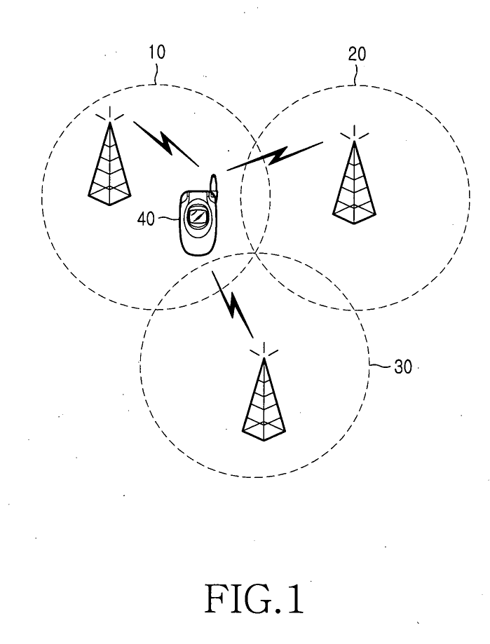

FIG. 1 is a diagram of a mobile Internet system. As illustrated in FIG. 1, in a mobile Internet system, which is generally referred to as a WiBro system, a base station is located in each of a plurality of cells 10, 20, and 30, and a mobile terminal 40 is connected to the base station in the cell 10 by synchronizing a reference frequency with the frequency of a signal output from the base station in the cell 10. Because the mobile terminal 40 registers the base stations in the adjacent cells 20 and 30 as frequency synchronization objects or frequency synchronization candidates, the mobile terminal 40 can obtain frequency synchronization information of the base stations in the cells 20 and 30 and thus move to the cell 20 or 30 during a handoff without an interruption in a call.

If the mobile terminal 40 obtains the frequency synchronization information of the cells 20 and 30 whose frequencies are in phase with the frequency of the cell 10 to which the mobile terminal 40 belongs, the mobile terminal 40 also holds three pieces of subcarrier frequency offset information corresponding to the cell 10 and the adjacent cells 20 and 30, respectively.

In the present invention, a moving speed of a mobile terminal is more accurately computed using the subcarrier frequency offset information. For example, the frequency offsets in the cells 10 through 30 are respectively A through C, where A=B=C in the same channel environment. Accordingly, when the mobile terminal 40 is currently located in the cell 10 and the subcarrier frequency offset is A, the subcarrier frequency offsets B and C in the adjacent cells 20 and 30 must be nearly the same as the subcarrier frequency offset A in the cell 10. Therefore, according to the present invention, it is possible to measure the moving speed of the mobile terminal 40 by using the subcarrier frequency offsets A, B, and C and to determine the average of the moving speeds as the moving speed.

If one of the subcarrier frequency offsets A through C is significantly less or greater than the other frequency offsets, the frequency offset is considered as being inaccurately measured due to a sudden, temporary change in the channel environment of the cell 10 to which the mobile terminal 40 belongs. Therefore, in this case, the frequency offset is ignored, and the moving speed is determined by computing the moving speeds using the other frequency offsets and the average of the computed moving speeds.

Because the mobile Internet system, i.e., the WiBro system, utilizes a multi-carrier mode using subcarriers, frequency offsets of the subcarriers must be more accurately compensated for than in the GSM mode or the CDMA mode that uses single carriers. Therefore, in the present invention, it is possible to more accurately compute the moving speed.

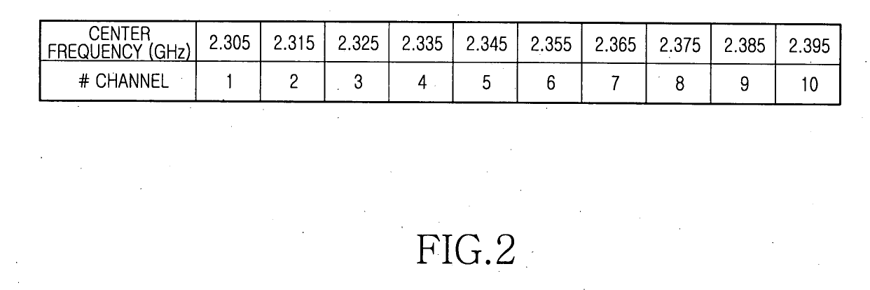

FIG. 2 is a table illustrating allocation of WiBro frequency channels at a channel frequency band of 10 MHz according to an embodiment of the present invention. Referring to FIG. 2, if a base station transmits a predetermined signal to a terminal at a frequency of 2.305 GHz via a channel 1, the terminal operates accurately in synchronization with the frequency of the channel 1. If the terminal operates at a fixed location without a movement, a signal output from the base station is received at the frequency of the channel 1. However, the movement of the terminal causes the difference in frequency between the signal transmitted from the base station and the signal received by the terminal. Such a phenomenon occurs due to a Doppler frequency. According to the present invention, a moving speed of the mobile terminal can be determined by computing the Doppler frequency.

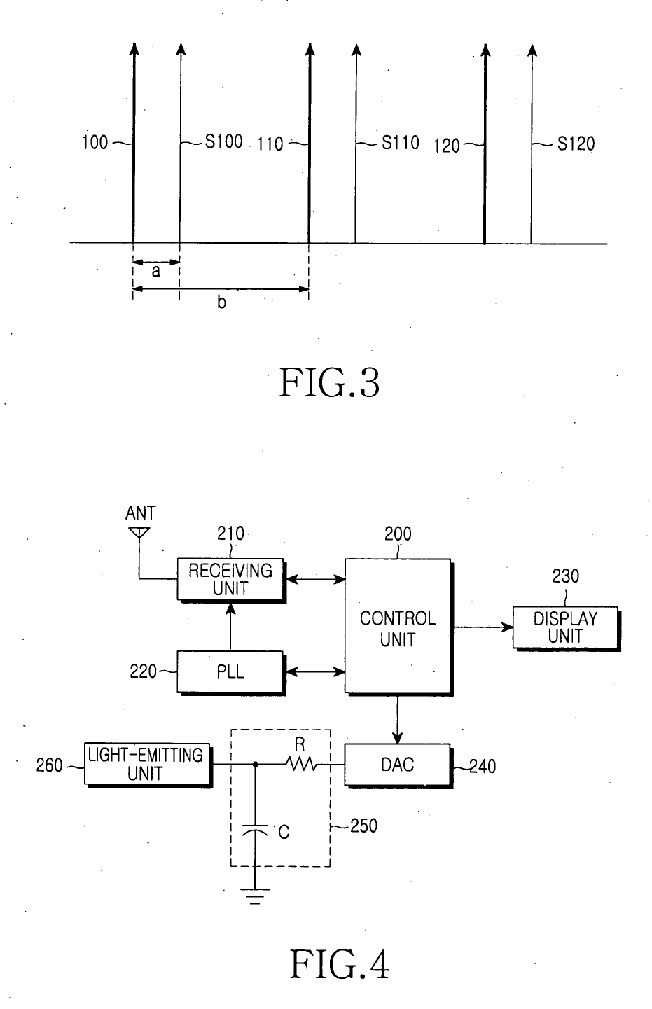

FIG. 3 illustrates frequency offsets of subcarriers according to an embodiment of the present invention. Referring to FIG. 3, if a frequency of a transmitter of a base station is not synchronized with that of a receiving unit of a terminal because of their different synchronization characteristics when subcarrier frequencies 100, 110, and 120, i.e., the original frequencies, are generated, Doppler frequencies S100, S110, and S120 corresponding to the frequencies 100, 110, and 120 are generated. In this case, a frequency offset a (frequency difference) between the Doppler frequency S100 and the subcarrier frequency 100 is generated, and thus, the subcarrier frequency 100 (the original frequency) is restored by compensating for the frequency offset a. Here, the frequency interval b between the subcarrier frequencies 100 and 110 is 9.765625 KHz, and the frequency interval between the subcarriers 110 and 120 is equal to the frequency interval b.

An RF frequency offset is obtained by measuring the frequency offset between sub carriers, and an offset of a received frequency is computed from the RF frequency offset. The moving speed is determined by the offset of the received frequency. According to the standard for mobile Internet, the frequency interval between subcarriers is 9.765625 KHz, and thus, the frequency offset of the received subcarrier must not be greater than 4.8828 KHz half the 9.765625 KHz. If the measured frequency offset of the received subcarrier is greater than 4.8828 KHz, the received subcarrier overlaps the subcarriers, thereby preventing signal recovery. Therefore, the moving speed also must be measured only in the case where the Doppler frequency does not exceed 4.8828 KHz.

The Doppler frequency can be computed using Equation (1). According to the present invention, the moving speed is determined by computing the Doppler frequency using Equation (1).
f′=(1+Vₒ/c).f (1)

In Equation (1), f denotes an available frequency used by a base station, f′ denotes a frequency received by the base station, c denotes the speed of a sound source, and Vₒ denotes the user's moving speed. In general, because WiBro is an electron wave, the speed of the sound source c is 3×10⁸ m/s corresponding to the speed of light and the received frequency f′ ranges from 2.3 GHz to 2.4 GHz.

Assuming that a frequency transmitted from the base station via a channel 1 is 2.305 GHz and a frequency offset of a subcarrier generated in the terminal is 100 Hz, i.e., when the available frequency f is 2.305 GHz and the received frequency offset is 100 Hz, the received frequency f′ is 2.305000100 GHz.

If the speed of light c, the available frequency f and the received frequency f′ are applied to Equation (1), Vₒ=13.015 m/s, that is, the moving speed is 46.85 Km/h. As described above, the moving speed can be more accurately computed when using a method of computing a moving speed from subcarrier frequency offsets according to the present invention than when using RF single carriers, and further, the resultant subcarrier frequency offsets are directly applied to the computing of the Doppler frequency, thereby fast computing the moving speed of the mobile terminal in real time.

According to another preferred embodiment, when the moving speed is computed by Equation (1) as described above, the terminal emits a color corresponding to the computed moving speed.

FIG. 4 illustrates a mobile communication terminal that emits a color corresponding to the moving speed according to an embodiment of the present invention. Referring to FIG. 4, the mobile communication terminal includes a control unit 200, a receiving unit 210, a phase-locked loop (PLL) 220, a display unit 230, a digital-to-analog converter (DAC) 240, a low-pass filter (LPF) 250, and a light-emitting unit 260. Although the mobile communication terminal according to the present embodiment includes the light-emitting unit 260, it would be apparent to those of ordinary skill in the art that the light-emitting unit 260 can be integrated into the display unit 230 or a keypad. For example, a light emitting diode (LED) unit may be mounted on a base of the keypad and include a plurality of multi-color light-emitting units to emit a color corresponding to the moving speed. Herein, both light-emitting units and the LCD unit can be used to emit a predetermined color, and thus, they are referred to as a light-emitting device. According to the present invention, a light-emitting device indicates the lighting emitting units installed into the display unit 230 or mounted to correspond to keys on the keypad, and/or the LED. Therefore, in this disclosure, the light-emitting unit 260 is used to indicate the light-emitting units and/or the LED.

Referring to FIG. 4, the control unit 200 controls the operations of the mobile communication terminal, such as call functions, and data transmission and receiving functions. In the present embodiment, when sensing the movement of the mobile communication terminal, the control unit 200 controls the light-emitting unit 260 to emit a color corresponding to the moving speed of the mobile communication terminal. In particular, the control unit 200 computes the moving speed of the mobile terminal by computing the Doppler frequency, and controls the light-emitting unit 260 to variously change a color corresponding to the computed moving speed.

In another embodiment of the present invention, the control unit 200 may control the computed moving speed to be displayed using numerals on the display unit 230.

In general, the mobile communication terminal performs wireless communications with a base station. The receiving unit 210 receives a radio-frequency (RF) signal from the base station via the Internet for wireless communications. The RF signal from the base station is transmitted to the control unit 200 via the receiving unit 210, and the control unit 200 measures the moving speed of the mobile terminal.

The PLL 220 performs an operation required to move to a frequency channel that the control unit 200 desires. More specifically, a voltage-controlled oscillator (VCO) (not shown) of the PLL 220 mixes a signal output from a mixer (not shown) of the receiving unit 210 with a signal output from the VCO, thereby performing frequency offset compensation at a desired frequency.

Accordingly, after the control unit 200 measures the moving speed, the DAC 240 that uses general purpose input/output (GPIO) operates according to the computed moving speed. In the present embodiment, the DAC 240, which converts a digital signal into an analog signal, outputs an analog signal, the size of which is changed to be proportional to the moving speed, under control of the control unit 200. That is, the control unit 200 outputs a control signal that controls an output of the DAC 240. The DAC 240 outputs a signal having a low V_{P-P} when the moving speed of the mobile terminal is low, and outputs a signal having a relatively high V_{P-P} when the moving speed is high. The analog signal output from the DAC 240 is applied to the LPF 250 that is an RC integrator. The analog signal passing through the LPF 250 is converted into a DC voltage that is in the range of 0 to 3V.

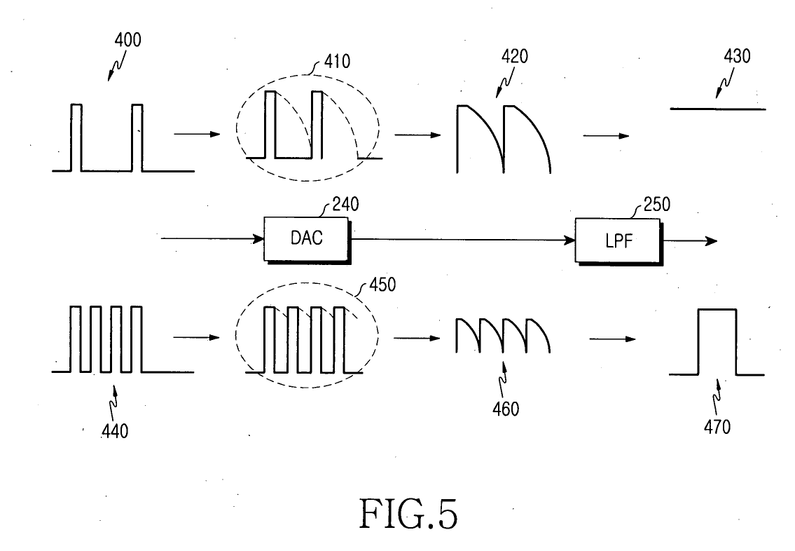

FIG. 5 is a view illustrating waveforms of a signal generated according to the moving speed of the mobile terminal according to an embodiment of the present invention. For example, if a signal output from the control unit 200 has a waveform 400 when the user is moving at a low speed, the signal output from the control unit 200 has a waveform 440 when the user is moving at a relatively high speed.

Referring to FIG. 5, when the signal output from the control unit 200 at the low speed is input to the DAC 240, the DAC 240 converts the digital signal, which was transformed into a frequency domain through Fast Fourier Transform (FFT) by the receiving unit 210, into an analog signal having a waveform 410. If the DAC 240 converts the signal output from the control unit 200 into an analog signal having a waveform 420. The analog signal output from the DAC 240 passes through the LPF 250 to be low-pass filtered, and is then output as a DC voltage 430. However, when the signal output from the control unit 200 at a relatively high speed is input to the DAC 240, the signal may be converted into an analog signal having a waveform 450, and a signal having a sawtooth waveform 460 may be output. When the signal having the waveform 460 is transmitted from the DAC 240 to the LPF 250, the LPF 250 generates a DC voltage 470 greater than the DC voltage 430. Herein, the DC voltage output from the LPF 250 does not exceed 3V.

The DC voltage output from the LPF 250 is applied to the light-emitting unit 260, and the light-emitting unit 260 emits a color corresponding to the applied DC voltage. That is, a change in the moving speed changes a signal output from the DAC 240, thus resulting in a change in the DC voltage. Therefore, the light-emitting unit 260 is controlled to emit a color corresponding to the changing voltage. The light-emitting unit 260 includes a plurality of multi-color emitting elements that emit two or more colors corresponding to the DC voltage.

As described above, the control unit 200 controls the light-emitting unit 260 to emit a color corresponding to the moving speed of the mobile terminal. For example, in order to change a color to be emitted according to the moving speed, the control unit 200 may control the light-emitting unit 260 to emit a loud color, such as red or blue, when the moving speed is high, and emit a smooth color, such as yellow or green, when the moving speed is low. That is, a color to be emitted is determined by a voltage output in proportion to the moving speed of the mobile terminal.

In another embodiment, the control unit 200 may control the computed moving speed to be displayed using a numerical display on the display unit 230. Accordingly, it is possible for the user to visually recognize the moving speed by checking an emitted color or a numeral displayed, thereby increasing user convenience.

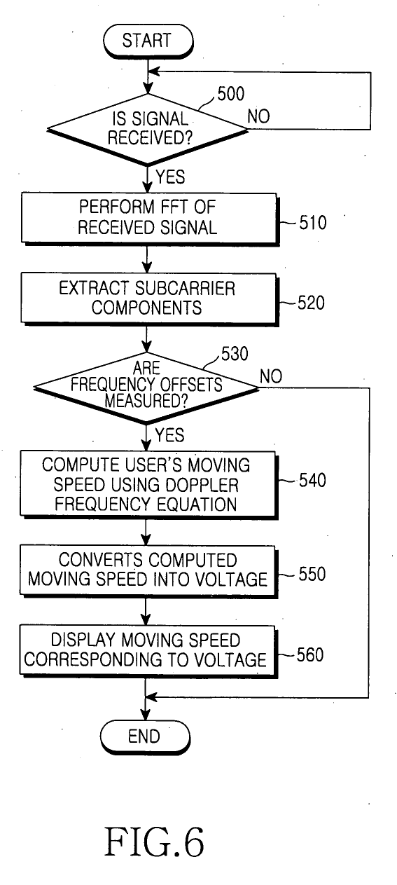

FIG. 6 is a flowchart illustrating a method of controlling a predetermined color to be emitted in a mobile communication terminal according to the moving speed, according to an embodiment of the present invention. Referring to FIG. 6, the control unit 200 determines if a signal is received from a base station via the receiving unit 210 in step 500. If the signal is received, the control unit 200 performs FFT on the received signal in step 510. Through FFT, the received signal in a temporal domain is transformed into a frequency domain.

In step 520, the control unit 200 extracts subcarrier components from the received signal in the frequency domain. The control unit 200 analyzes the extracted subcarrier components to determine whether the mobile communication terminal has been moved. If it is determined that the mobile communication terminal has been moved, the moving speed of the mobile communication terminal is computed.

Thereafter, the control unit 200 determines if the frequency offsets of the subcarriers are measured to compute the moving speed of the terminal in step 530. If it is determined that the subcarrier frequency offsets have been measured, the method proceeds to operation 540. A frequency available to a base station and a frequency received from the base station can be derived from the measured subcarrier frequency offsets.

More specifically, the control unit 200 computes the moving speed by applying the derived available frequency and received frequency to Equation (1), for example, which computes the Doppler frequency in step 540. In step 550, the control unit 200 converts the computed moving speed into a DC voltage. Thereafter, the control unit 200 controls the moving speed to be displayed, using the DC voltage corresponding to the moving speed in step 560. For example, the control unit 200 may control the moving speed to be displayed using either a color corresponding to the moving speed through the light-emitting unit 260, or displayed as a numeral on a display screen.

Accordingly, in a mobile communication terminal for use with mobile Internet according to the present invention, the moving speed of the mobile terminal is computed and visualized so that the user can conveniently view a current moving speed.

As described above, in a mobile communication terminal for use with mobile Internet according to the present invention, the moving speed of the mobile terminal is accurately computed from subcarrier frequency offsets, and visualized by emitting a color corresponding to the computed moving speed, thereby increasing user convenience and the utilities of the display functions of the mobile communication terminal.

While the present invention has been shown and described with reference to certain preferred embodiments thereof, it will be understood by those skilled in the art that various changes in form and details may be made therein without departing from the spirit and scope of the present invention. For example, in this disclosure, a light emitting device that changes a color to be emitted according to the moving speed of a mobile communication terminal, has been described using light-emitting units installed to correspond to keys on a display unit or a keypad, or an LED. However, it is obvious to those of ordinary skill in the art that the light emitting device may be an EL band or another light emitting material. Therefore, the scope of the present invention is not limited to the above described embodiments, but must be defined by the appended claims or the equivalence thereof.

What is claimed is:

1. An apparatus for displaying a moving speed of a mobile communication terminal for use with mobile Internet, the apparatus comprising:
a receiving unit for receiving a signal from a base station;
a phase-locked loop for transforming the signal received from the receiving unit into a desired frequency channel signal to measure subcarrier frequency offsets; and
a control unit computing the moving speed of the mobile communication terminal from the measured subcarrier frequency offsets.

2. The apparatus as clamed in claim 1, further comprising a light-emitting unit for emitting at least one color in response to a control signal corresponding to the computed moving speed of the mobile communication terminal.

3. The apparatus as claimed in claim 1, further comprising:
a digital-to-analog converter for converting a digital signal corresponding to the moving speed computed by the control unit into an analog signal; and
a low-pass filter receiving the analog signal from the digital-to-analog converter, converting the analog signal into a DC voltage, and applying the DC voltage to the light-emitting unit.

4. The apparatus as clamed in claim 1, wherein the control unit computes the moving speed by applying the measured subcairier frequency offsets to an equation that computes Doppler frequency.

5. The apparatus as claimed in claim 4, wherein the control unit computes a frequency received from the base station using the measured frequency offsets, and computes the moving speed of the mobile communication terminal using the received frequency, an available frequency used by the base station, and the speed of light.

6. The apparatus as claimed in claim 1, wherein the light-emitting unit comprises at least one of:
a display unit;
a light-emitting element installed corresponding to a key on a keypad; and
a light emitting diode.

7. The apparatus as claimed in claim 6, wherein the light-emitting unit emits different colors corresponding to the moving speed of the mobile communication terminal.

8. The apparatus as claimed in claim 1, further comprising a display unit for displaying the moving speed computed by the control unit.

9. A method of displaying a moving speed of a mobile communication terminal for use with mobile Internet, the method comprising the steps of:
extracting subcarrier components from a received signal by transforming the received signal into a frequency domain;
determining if the mobile communication terminal has moved by analyzing the extracted subcarrier components; and
computing the moving speed of the mobile communication terminal when it is determined that the mobile communication terminal has moved.

10. The method as claimed in claim 9, further comprising the step of emitting a color corresponding to the computed moving speed.

11. The method as claimed in claim 9, further comprising the steps of:
computing frequency offsets of the subcarriers when it is determined that the mobile communication terminal has moved;
outputting a voltage that is proportional to the moving speed of the mobile communication terminal using the computed frequency offsets; and
determining a color to be emitted according to the output voltage.

12. The method as claimed in claim 11, wherein the step of outputting the voltage comprises:
computing the moving speed of the mobile communication terminal using the computed frequency offsets; and
outputting a DC voltage based on the computed moving speed of the mobile communication terminal.

13. The method as claimed in claim 9, further comprising the step of numerically displaying the computed moving speed of the mobile communication terminal.
